(19) United States
(12) Patent Application Publication
(10) Pub. No.: US 2025/0187011 A1
(43) Pub. Date: Jun. 12, 2025

(54) SEALING CAP, MULTI-CARRIER CARTRIDGE, AND METHOD FOR PRODUCING THEREOF AND METHOD OF USING SAME

(71) Applicant: Xi'an Tianlong Science and Technology Co., Ltd, Xi An (CN)

(72) Inventors: Yao SUN, Xi An (CN); Hongdong LI, Xi An (CN); Shuanghua YUAN, Xi An (CN); Chengzhu ZHOU, Xi An (CN); Honggang GUO, Xi An (CN); Dajiang GONG, Xi An (CN); Zheng LI, Xi An (CN); Baogang MIAO, Xi An (CN)

(21) Appl. No.: 18/971,769

(22) Filed: Dec. 6, 2024

(30) Foreign Application Priority Data
Dec. 7, 2023 (CN) 202311667980.6

(51) Int. Cl. B01L 3/00

(52) U.S. Cl. CPC B01L 3/50853; B01L 2200/141; B01L 2200/185; B01L 2300/042; B01L 2300/0609

(57) ABSTRACT

A sealing cap, a multi-carrier cartridge, and an encapsulation method thereof and a method of using the same are provided. Exemplary the multi-carrier cartridge can be enclosed by several connection types with a cap frame and an encapsulation portion, which is capable of adapting to long-distance transport as well as being reclosed after use. The cap frame is mechanically connected to a cartridge body through a mechanical connection, achieving a reliable closure, and the encapsulation portion seals a liquid carrier through non-mechanical sealing connection, providing a reliable long-term sealing ability, The multi-carrier cartridge can be reclosed by secondary closure after use, which greatly reduces the risk of contamination.

### TECHNICAL FIELD

The present invention relates to the technical field of multi-carrier cartridges for sample treatment, in particular to a sealing cap, a multi-carrier cartridge, and method for producing thereof and method of using Same.

### BACKGROUND

In the healthcare industry, diagnostic tests are critical to properly diagnose medical problems. Measuring the accuracy and precision of diagnostic results is a necessary goal for companies to design products. To provide convenience, diagnostic systems have been created to accurately and precisely analyze samples in laboratories, clinics, hospitals, etc., but these systems often require multiple separated laboratories to coordinate test processing, which has the advantage of high sample throughput, but has smaller advantage in time, and makes it difficult to maintain operating costs with small sample volumes. The sample-in-result-out type system has received increasing attention, which has the advantages of small size and comprehensive functions. In recent years, those devices, methods, and diagnostic systems for detecting biomolecules such as nucleic acids have been widely used. Different solutions are usually required, such as lysis reagents, washing solutions, elution solutions, buffers. Multiple bottles containing these solutions must be connected to the diagnostic system, and the system must be matched with automated execution programs to extract appropriate liquids for testing. This requires the design of complex multi-well cartridges to match the sample-in-result-out assay needs.

Multi-well cartridges can be designed to realize different processing needs in a confined space. By connecting multiple orifices or well units, processing steps can be connected in series to achieve the goal of continuous processing, and for this reason, many manufacturers have designed different types of multi-well cartridges to meet different testing needs. U.S. Pat. No. 11,130,137B2 has disclosed a treatment solution for sealing different wells using a film, which can realize the long-distance leakage-free sealed storage. The sealing film needs to be punctured in use, and the disposable pipette tips used in this design are difficult to puncture the film, so it is necessary to design another type of pipette tip. If it is necessary to re-seal after being punctured, it is necessary to consider using rubber or other materials for the sealing film. However, the mostly used extraction solution used in molecular testing is magnetic beads transfer with a magnetic rod cover and a magnetic rod. If a film sealing solution is used, it is difficult to restore the reagent after the film being punctured. However, in case of unsealing, the cartridges will pose a serious risk of contamination to the experimenter, instrument, and environment after use. In order to ensure smoother puncture, some manufacturers have modified the thermoplastic sealing film solution with lower costs to a sputtering coating process, which can relatively reduce the thickness of the sealing film. However, this type of encapsulation also carries a higher risk of being punctured during transportation and does not solve the problem of subsequent cartridge sealing. The solution disclosed in US patent application U.S. 20210031181A1 proposes a separable cap body structure that can be used in conjunction with multiple parallel liquid circuit wells for waste liquid recovery and treatment. However, this design is only applicable to chemiluminescence detection systems and not to molecular diagnostic solutions. Chinese utility model patent CN212083235U discloses a chemiluminescence analysis kit capable of testing multiple targets to be analyzed. This structure combines the treatment and analysis kits, which may result in the kit being too long in size. However, a foldable flexible connection portion is designed to fold the kits of the treatment portion and the analysis portion, thereby solving the problem of difficult storage and transportation of the kits being too long. However, this design also does not solve the problem of how to seal them after use. In some disclosed solutions, the extraction consumables and pipette tips are combined, and a PCR consumable receiving position is reserved. The separable PCR tube can be placed in the receiving position in a heat-sealable during use, so that the PCR consumables tested by such amplification can be separated from the extraction consumables for sample treatment, ensuring the reliability of transportation. However, in this design, a film encapsulation solution is mostly used only for the extraction and treatment solutions, and the amplification consumables need to be separately encapsulated, which cannot achieve basic sealing after use, resulting in serious contamination.

From the above disclosed technology and the design of multi-well kits by some manufacturers, it is common to separate PCR amplification diagnostic kits from extraction and treatment kits in molecular diagnostics. The amplification reagents in the amplification kit are generally stored in lyophilized state or micro-liquid state in the amplification tubes, which are generally very small in volume and absorbed by a large capillary force, generating a small risk of leakage, whereas the extraction and treatment kits need to be configured with a larger volume and more treatment reagents due to the need to fully extract the samples, under which the capillary force can no longer constrain the liquids, and the general mechanical connection has the problem of being difficult to adapt to long-distance and harsh transportation conditions, while the simple use of film encapsulation solution requires the destruction of the film, resulting in difficulties in sealing after use. Therefore, it is necessary to design a kit that can adapt to long-distance and harsh transportation needs and can be sealed after use.

### SUMMARY

An object of the present invention is: to provide a sealing cap, a multi-carrier cartridge, and method for producing thereof and method of using Same, comprising a sealing cap structure of a cap frame and an encapsulation portion, in order to realize a multi-carrier cartridge that is capable of adapting to long-distance transport as well as realizing resealing after use. The cap frame is mechanically connected to a cartridge body through a mechanical sealing connection, achieving a reliable closure, and the encapsulation portion seals a liquid carrier through a seal fit, providing a reliable long-term sealing ability, The multi-carrier cartridge can be reclosed by secondary closure after use, which greatly reduces the risk of contamination.

The technical solution adopted by the present invention is as follows:
a sealing cap, comprising a cap frame and an encapsulation portion, wherein the cap frame is provided with a number of annular structures on one side and the encapsulation portion on the other side; and the annular structure can be mechanically connected to an opening connection portion of a carrier, wherein the encapsulation portion is made of a flexible material, which is able to form a non-mechanical sealing connection to an opening connection portion passing through an annular structure, and enable the carrier in a sealing state.

Furthermore, a number of annular structures comprise a through type annular structure that passes through the cap frame and a non-through type annular structure that forms a groove in the cap frame.

Furthermore, a plurality of annular structures are arranged at intervals along the length direction of the cap frame; and the annular structure near the cap frame end is a non-through type annular structure, and the annular structure in central section is a through type annular structure; wherein a non-through type annular structure is provided with a fastening structure that can be fastened to an opening connection portion of a carrier, which forms a first mechanical connection; wherein a through type annular structure can keep interference fit with an opening connection portion of a carrier, which forms a second mechanical connection.

Furthermore, the cap frame is designed with a number of opens that reducing the stiffness of the cap frame, and an open is located between two adjacent annular structures corresponding to two through type annular structures.

Furthermore, the encapsulation portion is in form of a film, and the thickness of which ranges from 0.01 to 0.2 mm.

A multi-carrier cartridge, comprising a cartridge body and a sealing cap, wherein the cartridge body and the sealing cap can be detachably connected; and the cartridge body comprising a number of carriers, which are provided with opening connection portions; and the sealing cap comprising a cap frame and an encapsulation portion, wherein the cap frame is provided with a number of annular structures on one side and an encapsulation portion on the other side; and an opening connection portion of a carrier can be mechanically connected to an annular structure; an opening connection portion of a carrier can form a non-mechanical sealing connection to the encapsulation portion passing through an annular structure, enabling the carrier in a sealing state.

Furthermore, ta number of annular structures comprise a through type annular structure that passes through the cap frame and a non-through type annular structure; wherein a number of carriers comprise a liquid carrier and a non-liquid carrier; and a liquid carrier which storing liquid corresponds to a through type annular structure, wherein a non-liquid carrier corresponds to a non-through type annular structure.

Furthermore, the cartridge body comprises a flange, and a plurality of carriers pass through the horizontal plane of the flange, by which they are connected to each other.

Furthermore, the distance of the liquid carrier protruding from the horizontal plane of the flange is greater than that of the non-liquid carrier.

Furthermore, a first fastening structure is located on the side wall of the opening connection portion corresponding to the non-liquid carrier, and a second fastening structure is located on the side wall of the annular structure; the first fastening structure can be fastened to the second fastening structure to form a first mechanical connection that can be opened and closed.

Furthermore, the first fastening structure is located on the side wall of the opening connection portion corresponding to the non-liquid carrier, and the second fastening structure is located on the side wall of a non-through annular structure; and the first fastening structure can be fastened to the second fastening structure, which forms the first mechanical connection; and the opening connection portion corresponding to the liquid carrier comprises an open side wall and a sealing side wall connected thereto, and the sealing side wall is located below the open side wall; and the outer wall diameter of the sealing side wall is greater than that of the open side wall, and the open side wall cooperates with the sealing forming a protruding-type structure; and the opening connection portion of the liquid carrier can be inserted into the corresponding annular structure, which forms the second mechanical connection by interference fit.

Furthermore, a number of carriers are arranged at intervals along the length of the cartridge body, the carrier at one end is a non-liquid carrier and the carrier in the middle is a liquid carrier.

Furthermore, a non-liquid carrier comprises a number of consumable receiving sub-wells, and the consumable receiving sub-wells corresponding to the same non-liquid carrier are adjacent to each other, which share the same opening connection portion.

A method for producing a multi-carrier cartridge, wherein the multi-carrier cartridge comprises a cartridge body and a sealing cap, wherein the cartridge body and the sealing cap can be detachably connected; and the cartridge body comprises a number of carriers, which are provided with opening connection portions; and the sealing cap comprises a cap frame and an encapsulation portion, wherein the cap frame is provided with a number of annular structures on one side and an encapsulation portion on the other side; wherein the encapsulation portion is in form of a film; wherein the method for producing the multi-carrier cartridge comprises the following steps:

loading step: placing various objects to a number of carriers;
assembling step: assembling the cap frame to the top of the cartridge body so that an opening connection portion of a carrier can be inserted into can be inserted into the corresponding annular structure;
connecting the encapsulation portion step: connecting the encapsulation portion to the cap frame by means of gluing or thermal encapsulation;
encapsulating step: gluing or thermal encapsulation the contacting area between the opening connection portion and the encapsulation portion, which forms non-mechanical sealing connection; wherein connecting the encapsulation portion step is synchronized with encapsulating step forming a one-step encapsulation method, or which is performed prior to the assembly step forming a two-step encapsulation method.

Furthermore, a number of annular structures comprise a through type annular structure that passes through the cap frame and a non-through type annular structure that forms a groove in the cap frame; wherein a number of carriers comprises a liquid carrier and a non-liquid carrier; and a liquid carrier which storing liquid corresponds to a through type annular structure and a non-liquid carrier corresponds to a non-through type annular structure; wherein the first fastening structure is located on the side wall of the opening connection portion corresponding to the non-liquid carrier, and the second fastening structure is located on the side wall of a non-through type annular structure; wherein the first fastening structure can be fastened to the second fastening structure, which forms the first mechanical connection; and the opening connection portion of the liquid carrier can be inserted into the corresponding annular structure, which forms the second mechanical connection by interference fit; during the loading step, wherein a liquid carrier is loaded with liquid, and a non-liquid carrier is loaded with a non-liquid material; during the assembling step, wherein the opening connection portion corresponding to the non-liquid carrier is mechanically connected to the corresponding annular structure, which forms a first mechanical connection, wherein the opening connection portion of the liquid carrier achieves interference fit to the corresponding annular structure, which forms the second mechanical connection, and the opening connection portion of the liquid carrier passes through the corresponding annular structure; and during encapsulating step, the opening connection portion of the liquid carrier and the encapsulation portion forms a non-mechanical sealing connection.

A method of using a multi-carrier cartridge, wherein the multi-carrier cartridge comprises a cartridge body and a sealing cap, wherein the cartridge body and the sealing cap can be detachably connected; and the cartridge body comprises a number of carriers, which are provided with opening connection portions; and the sealing cap comprises a cap frame and an encapsulation portion; wherein the cap frame is provided with a number of annular structures on one side and the encapsulation portion on the other side; wherein the encapsulation portion is in form of a film; wherein an opening connection of a carrier can form a non-mechanical sealing connection to the encapsulation portion passing through an annular structure, enabling the carrier in a sealing state; wherein a number of annular structures comprise a through type annular structure that passes through the cap frame and a non-through type annular structure that forms a groove in the cap frame; wherein a number of carriers comprise a liquid carrier and a non-liquid carrier; and a liquid carrier which storing liquid corresponds to a through type annular structure and a non-liquid carrier corresponds to a non-through type annular structure; wherein the first fastening structure is located on the side wall of the opening connection portion corresponding to the non-liquid carrier, and the second fastening structure is located on the side wall of a non-through annular structure; wherein the first fastening structure can be fastened to the second fastening structure, which forms the first mechanical connection; and the opening connection portion of the liquid carrier can be inserted into the corresponding annular structure, which forms the second mechanical connection by interference fit; wherein the method of using the multi-carrier cartridge comprises the following stages:

encapsulated-state: adding sample-associated reagents to a liquid carrier of the multi-carrier cartridge, placing the magnetic rod cover and/or a pipette tip in a non-liquid carrier, assembling the cap frame to the cartridge body, so that the annular structure is mechanically connected to the opening connection portion of the corresponding carrier, and the non-liquid carrier is closed, wherein the encapsulation portion is connected to the cap frame, meanwhile, which forms non-mechanical sealing connection making the cartridge turning into an sealed-state cartridge;
operated stage: applying an external force to the sealing cap, causing the cap frame and encapsulation portion to detach from the cartridge body together, making the cartridge body in the uncapped state, and transferring the sample liquid or magnetic beads to a liquid carrier for extraction and purification by using the pipette tip and/or the magnetic rod cover;
closed stage: after completing the reaction, reclosing the cartridge body and the sealing cap again, making the carrier and the sealing cap mechanically connected, so that the consumable body is in a capped state to avoid causing contamination.

To sum up, by using the above-mentioned technical solution, the present invention has the following beneficial effects:
1. The present invention divides the sealing cap of the multi-carrier cartridge into two parts, the cap frame and the encapsulation portion, by the separating design thinking. The cap frame corresponds to the carrier of the cartridge body, which needs to be effectively sealed because of the different types of treatment solutions to be configured within the cartridge body. The present invention first provides an annular structure at the cap frame, enabling the cartridge body to be connected to the annular structure, and then the encapsulation portion is connected to at least part of the cap frame and at least part of the carrier by gluing or thermal encapsulation forming a non-mechanical sealing connection, so that the cap frame mainly plays a supporting role, and the long-term sealing connection mainly relies on the non-mechanical sealing connection between the cartridge body and the encapsulation portion. During use, the cap frame and the encapsulation portion are detached from the cartridge body together, and the cap body can be fastened and connected by interference fit to the cartridge body by the cap frame after use, realizing reclosing the cartridge body, without damaging the encapsulation portion, which can complete the extraction without obstruction. Then, it only requires resecuring the sealing cap be onto the cartridge body to achieve mechanical connection of the multi-carrier cartridge, which can minimize the risk of contamination.
2. In the present invention, the same first material is used for the cap frame and the cartridge body, resulting in strong connection reliability between the cap frame and the cartridge body during use. The aluminum foil, different from the first material, is used for the encapsulation portion, and the sealing of the encapsulation portion is gluing or thermal encapsulation, further ensuring the reliability of non-mechanical sealing connection. The cap frame comprises multiple annular structures, which can also form mechanical connection with the side walls of the opening connection portion of the carrier, retaining the advantage of easy opening and closing of the mechanical connection. At the same time, the encapsulation portion can non-mechanical seal the liquid carrier, combining the advantages of two different connections. The liquid carrier should be sealed by more reliable non-mechanical sealing connection during encapsulation, and the carrier in the multi-carrier cartridge can be reclosed more simply and reliably from contamination by mechanical connection after use.
3. The method of preparing the multi-carrier cartridge provided by the present invention involves filling the carrier of the cartridge body with corresponding reagents and placing required non-liquid materials. Then, a one-step encapsulation method, a two-step encapsulation method, a thermal encapsulation method, or a glued encapsulation method is used to connect the encapsulation portion to the cartridge body and the cap frame. The encapsulation portion can be in a non-mechanical sealing connection to the cartridge body. At the same time, the cap frame is fastened to the cartridge body, retaining the advantages of easy opening and closing of the mechanical connection. Combining the advantages of the two different connections, it ensures that it is convenient to manufacture and process consumables which can adapt to the requirements of long-distance transport without leakage. The overall process is simple and the reliability obtained is higher.

### BRIEF DESCRIPTION OF DRAWINGS

FIG. 1 is a structural diagram of a multi-carrier cartridge provided by an embodiment of the present invention;

FIG. 2 is a structural diagram of the cartridge body;

FIG. 3 is a structural profile of FIG. 2;

FIG. 4 is a back structural diagram of the cap frame in the sealing cap of FIG. 1;

FIG. 5 is a front view of the cap frame;

FIG. 6 is a sectional view of the side of the cap frame;

FIG. 7 is a perspective schematic view of the cap frame in a top view direction after being mechanically connected to the cartridge body;

FIG. 8 is a structural diagram of the encapsulation portion; and

FIG. 9 is a structural profile of a multi-carrier cartridge provided by an embodiment of the present invention.

Explications: 10—cartridge body, 101—flange, 110—first opening connection portion, 111—first side bulge, 120—second liquid carrier, 121—second opening connection portion, 122—second tube body structure, 130—third liquid carrier, 131—third opening connection portion, 132—third tube body structure, 140—fourth liquid carrier, the 141—fourth opening connection portion, 142—fourth tube body structure, 150—fifth liquid carrier, 151—fifth opening connection portion, 152—fifth tube body structure, 160—sixth liquid carrier, 161—sixth opening connection portion, 162—sixth tube body structure, 170—seventh liquid carrier, 171—seventh opening connection portion, 172—seventh tube body structure, 180—magnetic rod cover storage sub—well, 89—eighth opening connection portion, 891—second side bulge, 190—eluent pipitte tip storage sub-well, 20—cap frame, 201—first open, 202—second open, 203—third open, 204—fourth open, 205—fifth open, 210—first fastening portion, 211—first side recess, 220—second tabling portion, 221—first hollow, 222—first tabling structure, 230—third tabling portion, 231—second hollow, 232—second tabling structure, 240—fourth tabling portion, 241—third hollow, 242—third tabling structure, 250—fifth tabling portion, 251—fourth hollow, 252—fourth tabling structure, 260—sixth inlay portion, 261—fifth hollow, 262—fifth inlay structure, 270—seventh tabling portion, 271—sixth hollow, 272—sixth inlay structure, 280—eighth fastening portion, 281—second side groove, 282—limit groove, 30—encapsulation portion, 1001—first mechanical connection, 1002—second mechanical connection, 2001—non-mechanical sealing connection.

### DETAILED DESCRIPTION OF THE EMBODIMENTS

The present invention will be described in detail below in conjunction with the accompanying drawings.

The present invention will be further described in detail in combination with drawings and embodiments for a clearer understanding of the object, technical solution and advantages of the present invention. It should be understood that the specific embodiments described herein are only used to explain rather than limit the present invention.

### Embodiment 1

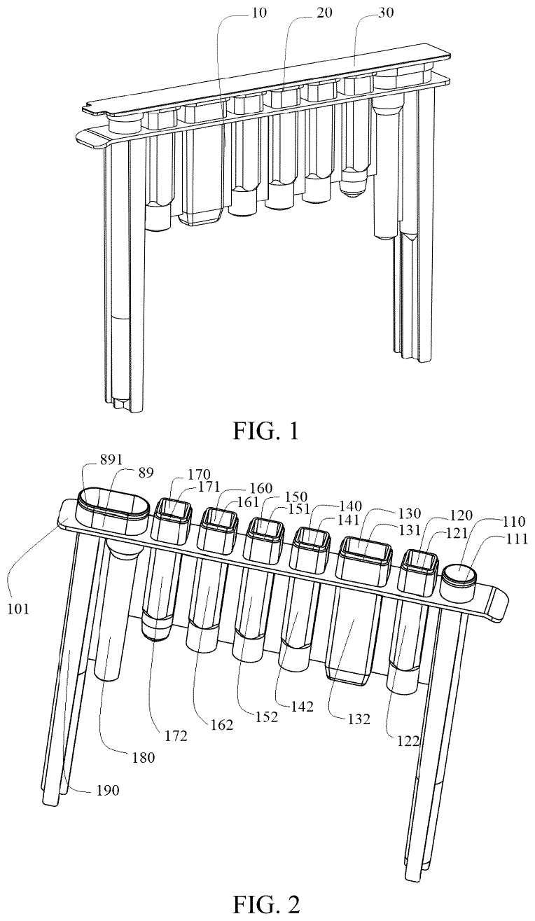

Referring to FIG. 1, FIG. 1 is a structural diagram of a multi-carrier cartridge provided by an embodiment of the present invention, and the multi-carrier cartridge is of a multi-carrier type; the multi-carrier cartridge comprises a cartridge body 10 and a sealing cap fastened onto the top of the cartridge body 10, and the sealing cap comprises a cap frame 20 and an encapsulation portion 30.

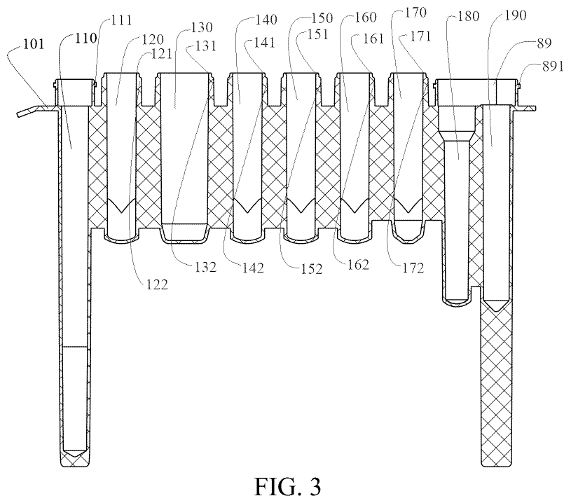

Specifically, with reference to FIG. 2 and FIG. 3, FIG. 2 is a structural diagram of the cartridge body, and FIG. 3 is a structural profile of FIG. 2. The cartridge body 10 comprises a flange 101 and connects a plurality of carriers via the flange 101, the carrier comprises a liquid carrier and a non-liquid carrier, and the carrier comprises an opening connection portion configured at the top.

Specifically, the opening connection portion corresponding to the liquid carrier comprises an open side wall and a sealing side wall connected thereto, and the sealing side wall is located below the open side wall; the outer wall diameter of the sealing side wall is greater than that of the open side wall, and the open side wall and the sealing side wall cooperate with each other to form a protruding-type structure; the opening connection portion of the liquid carrier can be inserted into the corresponding annular structure and form a second mechanical connection 1002 with the annular structure through interference fit. There are six liquid carriers for storing the reserved liquids, namely a second liquid carrier 120, a third liquid carrier 130, a fourth liquid carrier 140, a fifth liquid carrier 150, a sixth liquid carrier 160 and a seventh liquid carrier 170.

Specifically, the second liquid carrier 120 comprises a second opening connection portion 121 and a second tube body structure 122. The second opening connection portion 121 is located above the flange 101, the second tube body structure 122 is located below the flange 101, and the second tube body structure 122 is molded into either a cylindrical wall or a slight angle tapered wall. Specifically, the second liquid carrier 120 can be served as a receiving portion of proteinase K. the present embodiment realizes the rupture of the nucleocapsid in sample testing by providing the second liquid carrier 120 which can be served as a receiving portion of proteinase K. the present embodiment makes the multi-carrier cartridge compatible with a wide range of objects for testing, such as bacteria and viruses. The third liquid carrier 130 comprises a third opening connection portion 131 and a third tube body structure 132. The third opening connection portion 131 is located above the flange 101, the third tube body structure 132 is located below the flange 101, and the third liquid carrier 130 is a lysing hole. In order to ensure that the sample liquid is more fully lysed, the cross section of the third liquid carrier 130 is configured to be able to provide a long strip structure with a certain movement stroke for a device along the length direction of the cartridge body. In the present embodiment, in order to ensure the lysis efficiency, the third liquid carrier 130 is configured as a rectangular structure with a cross-sectional aspect ratio of 1.2-2.5, and preferably, the width at the cross-sectional area ranges from 6 to 9 mm, which can ensure that there is sufficient operating space for the magnetic rod cover to perform the extraction and the uniformity of distribution of the nucleic acid fragment in the lysate in which the extraction is completed does not decrease due to the size being too large, and the nucleic acid fragment yield remains same. Similarly, the fourth liquid carrier 140, the fifth liquid carrier 150, the sixth liquid carrier 160, and the seventh liquid carrier 170 further comprise a fourth opening connection portion 141, a fifth opening connection portion 151, a sixth opening connection portion 161, and a seventh opening connection portion 171, respectively, as well as a fourth tube body structure 142, a fifth tube body structure 152, a sixth tube body structure 162, and a seventh tube body structure 172. The fourth liquid carrier 140 is a magnetic beads storage hole, in which magnetic beads particles are dispersed in the magnetic beads storage solution, thereby achieving long-term storage and highly automated encapsulation of magnetic beads particles. The fifth liquid carrier 150 and the sixth liquid carrier 160 are both washing holes to allow for two washing schemes, the two washing schemes make the washing more efficient, and the seventh liquid carrier 170 is an elution hole. In addition, the present embodiment configures the fourth liquid carrier 140, the fifth liquid carrier 150, the sixth liquid carrier 160, and the seventh liquid carrier 170 to be of the same or similar sizes, so that the magnetic rods in conjunction with the magnetic rod covers are able to perform the bead transferring, washing, and eluting operations with essentially the same efficiency, thus achieving simpler automated control.

The non-liquid carrier comprises a second well and a first well; in the present embodiment, the cartridge body 10 comprises a first well that serves as a first pipette tip receiving portion. The first pipette tip receiving portion has a first capacity capable of transferring a sample liquid to be extracted and purified. In other embodiments, the cartridge body 10 can comprise a plurality of first wells; the second well is different from the first well. Furthermore, the second well comprises a plurality of consumable receiving sub-wells. In the present embodiment, there are two consumable receiving sub-wells, and the tops of the two consumable receiving sub-wells are connected to form a common eighth opening connection portion 89. The two consumable receiving sub-wells are respectively a magnetic rod cover storage sub-well 180 and an eluent pipitte tip storage sub-well 190. In order to perform magnetic beads extraction operations, a magnetic rod cover is provided inside the magnetic rod cover storage sub-well 180. The eluent pipitte tip storage sub-well 190 is used for storing the second pipitte tip, which can transfer eluent and PCR premix distribution.

Preferably, the cartridge body 10 further comprises a flange 101, a first well, a liquid carrier and a second well provided in order side by side and penetrating the horizontal plane of the flange 101 and connected to each other by the flange 101. The first well and second well can be defined as different non-liquid carriers. The present embodiment can ensure reliable connection between the carriers while enhancing the strength of the cartridge body 10 through the configured flange 101.

In the first well, the liquid carrier, and the second well comprised in the cartridge body 10, each second well unit comprises two sub-wells, and each first well and each liquid carrier comprises only one sub-well, and the number N of sub-wells in the present embodiment is 9. In some cases, N may be 7, 8, 10, 11, 12, and so on. Preferably, N is an integer greater than or equal to 7 and less than or equal to 12, which ensures that the multi-carrier cartridge is not too short to cause inadequate extraction, which affects the accuracy of the test results, and not too long to make the extraction step too cumbersome, resulting in the risk of contamination and the high cost of realization.

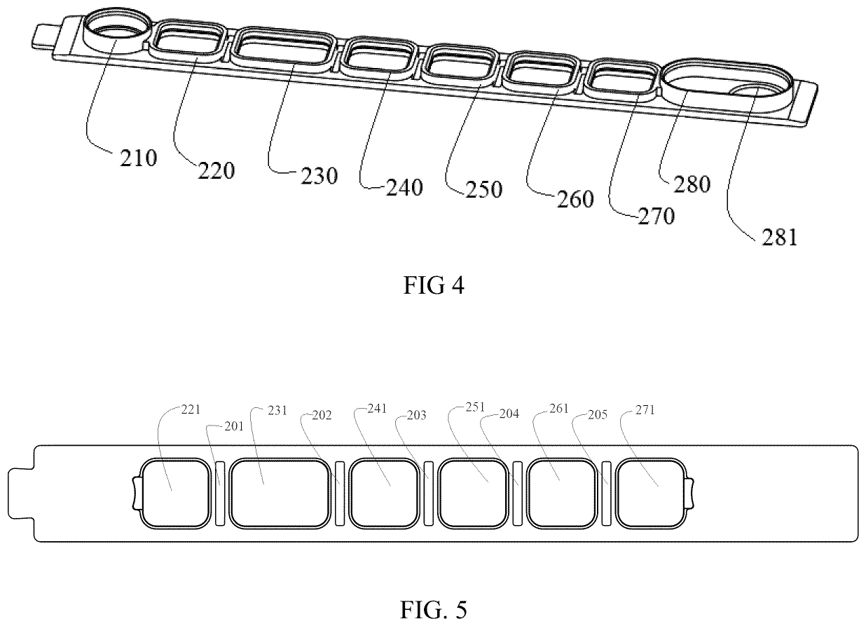

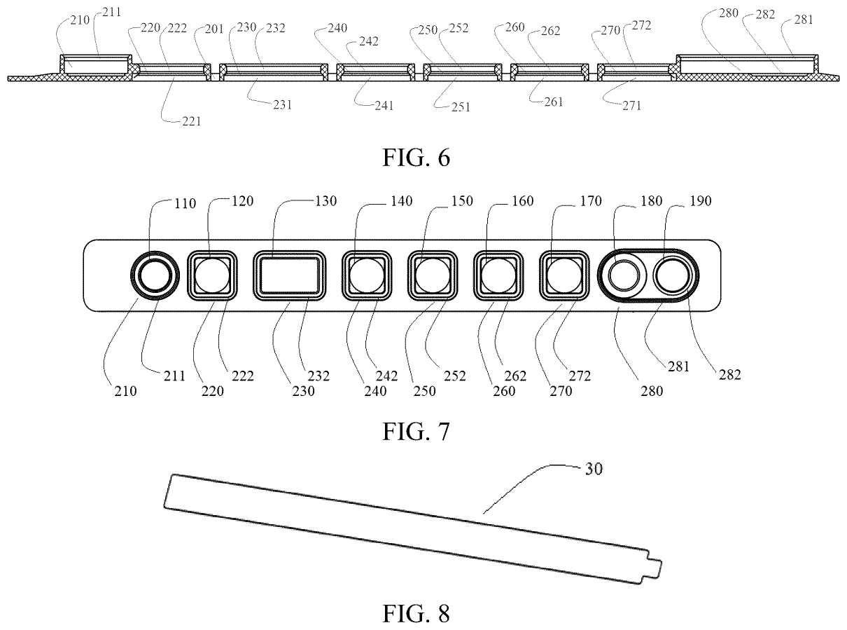

Referring to FIG. 4, FIG. 5 and FIG. 6, FIG. 4 is a back structural diagram of the cap frame in the sealing cap of FIG. 1, FIG. 5 is a front view of the cap frame, FIG. 6 is a sectional view of the side of the cap frame, and FIG. 7 is a perspective schematic view of the cap frame in a top view direction after being mechanically connected to the cartridge body. The sealing cap comprises a cap frame 20 and an encapsulation portion 30, and the cap frame is provided with annular structures; a first fastening structure is located on the side wall of the opening connection portion corresponding to the non-liquid carrier, and a second fastening structure is located on the side wall of the annular structure; the first fastening structure can be fastened to the second fastening structure to form the first mechanical connection 1001 that can be opened and closed, therefore they can be detachably connected. The opening connection portion of the liquid carrier can be inserted into the corresponding annular structure to form the second mechanical connection 1002 by means of interference fit, and the encapsulation portion 30 is connected to the liquid carrier which passes through the annular structure in non-mechanical sealing connection to ensure that the liquid carrier is in a reliable sealing state; after the sealing cap is removed from the cartridge body 10, the first mechanical connection 1001, the second mechanical connection 1002, and the non-mechanical sealing connection are all released, and the cartridge body 10 is in an uncapped state; the sealing cap is reclosed with the cap frame 20 to which the encapsulation portion 30 is connected, restoring the first mechanical connection 1001 and the second mechanical connection 1002, and making the cartridge body 10 be in a capped state. The multi-carrier cartridge provided in the present embodiment has a higher reliability of non-mechanical sealing connection between the liquid carrier and the encapsulation portion 30 making the liquid carrier be in a sealing state, which is suitable for long-term storage and harsh transportation conditions. After being reclosed, the cartridge body 10 is in a capped state. A plurality of annular structures are arranged at intervals along the length direction of the cap frame; the annular structure at the end is a non-through type annular structure, and the annular structure in the middle is a through type annular structure; the non-through type annular structure can be fastened to the corresponding opening connection portion to form the first mechanical connection 1001, and the annular structure of the through type annular structure can keep interference fit with the corresponding opening connection portion of the carrier to form the second mechanical connection 1002. Due to the fact that the encapsulation portion 30 and the cap frame 20 are still encapsulated into an integrated sealing cap, this structure can achieve mechanical fastening characteristic similar to a hard cap or a whole cap, and ensure the reliability of the reclosure through the first mechanical connection 1001 on both sides. At the same time, it can also use automatic capping schemes similar to those disclosed in CN115232710A or CN111847343B to perform the reclosure, without the need to change the automatic capping equipment, making consumables more adaptable and conducive to the promotion of use.

The first fastening structure at the opening connection portion of the non-liquid carrier is a side bulge, and the second fastening structure corresponding to the annular structure is a side recess at the inner wall, so that when the annular structure is covered at the opening connection portion of the non-liquid carrier, the side bulge is fastened in the side recess to realize the first mechanical connection 1001. A first seal bulge 111 is provided as a first fastening structure on a side wall of the first opening connection portion 110 corresponding to the first well near the opening, and the first side bulge 111 can ensure reliable connection between the first opening connection portion 110 and the sealing cap; a second side bulge 891 is configured as a first fastening structure on a side wall of the eighth opening connection portion 89.

The annular structure of the liquid carrier comprises a tabling portion, and when the annular structure is socketed to the liquid carrier, the tabling portion keeps interference fit to the sidewall of the opening connection portion to form the second mechanical connection 1002, specifically, the opening connection portion can function as a guide for alignment during the connection process, and the tabling portion is covered on the opening connection portion for fixing, so that the connection is reliable and precise. After the opening connection portion passes through the annular structure, the top of the opening connection portion is connected to the encapsulation portion 30 to form a non-mechanical sealing connection 2001.

In the present embodiment, the cap frame 20 can be fastened to the cartridge body 10. Specifically, the annular structure of the cap frame 20 comprises a first fastening portion 210, a second tabling portion 220, a third tabling portion 230, a fourth tabling portion 240, a fifth tabling portion 250, a sixth tabling portion 260, a seventh tabling portion 270, and an eighth tabling portion 280. The first fastening portion 210 cooperating with the first well is provided with a first side recess 211; the second tabling portion 220 cooperating with the second liquid carrier 120 is provided with a first hollow portion 221 and a first tabling structure 222; the third tabling portion 230 cooperating with the third liquid carrier 130 is provided with a second hollow portion 231 and a second tabling structure 232; the fourth tabling portion 240 cooperating with the fourth liquid carrier 140 is provided with a third hollow portion 241 and a third tabling structure 242, similarly, the fifth tabling portion 250 cooperating with the fifth liquid carrier 150 is provided with a fourth hollow portion 251 and a fourth tabling structure 252, and the sixth tabling portion 260 cooperating with the sixth liquid carrier 160 is provided with a fifth hollow portion 261 and a fifth tabling structure 262; the seventh tabling portion 270 cooperating with the seventh liquid carrier 170 is provided with a sixth hollow portion 271 and a sixth tabling structure 272; the eighth fastening portion 280 used in conjunction with the magnetic rod cover storage sub-well 180 and the eluent pipitte tip storage sub-well 190 is provided with a second side recess 281, and the second side recess 281 is provided on an inner wall of the eighth fastening portion 280, in order to accommodate the and limit the eluent pipitte tip to avoid the eluent pipitte tip from shaking substantially within the eluent pipitte tip storage sub-well 190, resulting in transportation damage; a limit groove 282 is provided at the opposite position of the cap frame 20 and the eluent pipitte tip storage sub-well 190 for clamping the end of the eluent pipitte tip.

Opens are located between the annular structures of the through type annular structure on the cap frame 20, which allow the annular structures of the through type annular structure to be spaced apart from each other to reduce the stiffness of the cap frame 20. Specifically, in the present embodiment, five opens are configured between the annular structure of the cap frame 20, namely a first open 201, a second open 202, a third open 203, a fourth open 204, and a fifth open 205. Such a provision can locally reduce the stiffness of the cap frame 20, allowing the cap frame 20 fastened to the cartridge body 10 to be resiliently adjusted.

Referring to FIG. 8, FIG. 8 is a structural diagram of the encapsulation portion. The encapsulation portion 30 caps and connects the cap frame 20, thereby forming an integrated sealing cap, and the encapsulation portion 30 is in non-mechanical sealing connection to the liquid carrier which passes through the annular structure, enabling the liquid carrier to be reliably sealed.

Specifically, the encapsulation portion 30 can be cut and molded to the same or similar shape as the cap frame 20, or can be cut to a rectangular shape. The encapsulation portion 30 is in the form of a film, and preferably the thickness dimension of the encapsulation portion 30 ranges from 0.01 to 0.2 mm. There is a risk of insufficient strength in the too thin encapsulation portion 30, while the too thick encapsulation portion 30 may cause problems such as unreliable encapsulation connection or complex encapsulation connection processes. The encapsulation portion 30 may be a metallic foil, such as aluminum foil, tin foil, copper foil, gold foil, or it may be a non-metallic film, e.g., the encapsulation portion 30 is a plastic film.

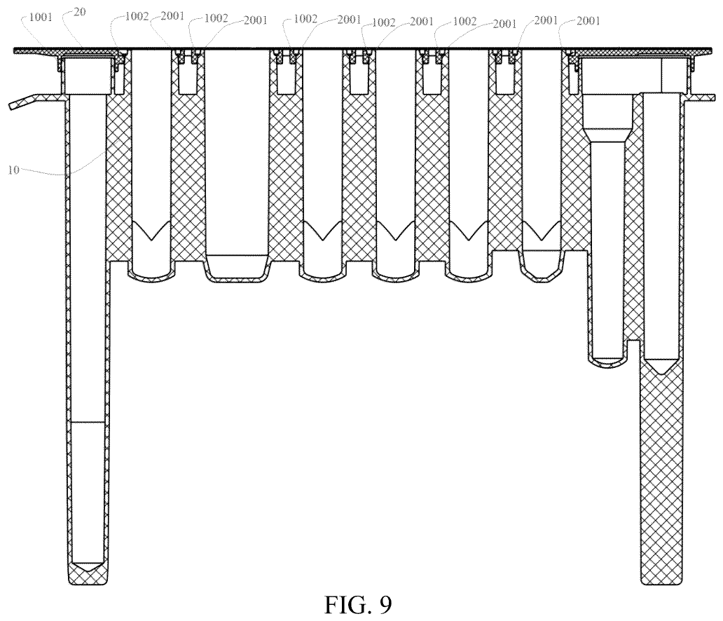

Referring to FIG. 9, FIG. 9 is a structural profile of a multi-carrier cartridge provided by an embodiment of the present invention. In the present embodiment, the first well and the second well are both non-liquid carriers, and the first well and the second well are respectively provided with a first side bulge 111 and a second side bulge 891 as a first fastening structure capable of detachably connecting the first side recess 211 and the second side recess 281, respectively. The annular structure corresponding to the liquid carrier is provided as an open structure, not the first fastening structure similar to the non-liquid carrier, and at the same time, the corresponding annular structure is not provided with the second fastening structure, so that the resistance in the process of fastening the cartridge body 10 and the cap frame 20 can be reduced, and meanwhile, it is possible to avoid the problem of the reliability of local sealing being reduced due to the obstruction of the first fastening structure during the socketing of the annular structure. The opening connection portion comprised in the liquid carrier is of a protruding-type structure, which makes it easier to pass through the annular structure of the cap frame 20. In addition, the opening connection portion of the liquid carrier, projects the same or a similar height above the horizontal plane where the flange 101 is located, such that when the cartridge body 10 is fastened to the cap frame 20, the opening connection portion of the liquid carrier can also project the same or a similar height above the horizontal plane where the cap frame 20 is located. Preferably, the distance of the opening connection portions of the liquid carrier, beyond the horizontal plane where the top of the cap frame 20 fastened to the cartridge body 10 is located, is in the range of 0.1 to 1.1 mm, in order to guarantee that the encapsulation portion 30 can be uniformly and consistently connected to the opening connection portions of the liquid carriers. In addition, the height of the liquid carrier protruding from the flange is greater than the height of the non-liquid carrier protruding from the horizontal plane of the flange 101, in order to enable the non-liquid carrier to be in sealing connection to the cap frame 20 via the fastening structure of the annular bulge. Preferably, the absolute height difference between projecting height for the liquid carrier beyond the horizontal plane of the flange 101, and which height for the non-liquid carrier beyond the horizontal plane of the flange 101 is 1.1-2.1 mm. This is because a too low height difference does not ensure reliable connection of the liquid carrier which passes through the opening connection portion of the annular structure to the encapsulation portion 30, and a too high height difference results in a risk of the liquid carrier puncturing the encapsulation portion 30.

The sealing principle of the present invention is described below. After the first well of the cartridge body 10 is fastened to the sealing cap of the cap frame 20, the first fastening portion 210 forms first mechanical connection 1001 with the first well, and the first mechanical connection 1001 indicates that the sealing cap is detachably connected to the first well. Furthermore, the first side bulge 111 is cooperatively fastened to the first side recess 211 to form the first mechanical connection 1001. The second liquid carrier 120 passes through the first hollow 221 of the cap frame 20 such that the second tabling portion 220 is covered to a side wall of the second opening connection portion 121, and the sidewall of the second opening connection portion 121 is in interference fit to the first tabling structure 222 to form the second mechanical connection 1002. Non-mechanical sealing connection 2001 is formed between the encapsulation portion 30 and the liquid carrier, the cap frame 20, and the non-mechanical sealing connection is specifically flexible sealing connection, which may be made by gluing or thermal encapsulation to keep sealing connection between the encapsulation portion 30 and the liquid carrier and/or the cap frame 20, and specifically, the top of the second opening connection portion 121 is glued or thermally encapsulated with the encapsulation portion 30 to form non-mechanical sealing connection 2001. Similarly, the third liquid carrier 130, the fourth liquid carrier 140, the fifth liquid carrier 150, the sixth liquid carrier 160, and the seventh liquid carrier 170, respectively, are fastened into place to the cap frame 20, with the side walls of the opening connection portions forming the second mechanical connection 1002 with the corresponding annular structures, while the third liquid carrier 130, the fourth liquid carrier 140, the fifth liquid carrier 150, the sixth liquid carrier 160, and the seventh liquid carrier 170 each form non-mechanical sealing connection 2001 with the encapsulation portion 30 on the top of the opening connection portion. Similar to the first well, the second well cooperates with the eighth fastening portion 280 to form a first mechanical connection 1001 (not shown in the figures), while the cap frame 20 and the encapsulation portion 30 form a first sealing type connection by gluing or thermal encapsulation, and the first sealing type connection is more than five times the area of the non-mechanical sealing connection 2001. Preferably, the ratio of the area of the first sealing type connection to the area of the non-mechanical sealing 2001 is 5 to 50 times. A too small area ratio may cause the encapsulation portion 30 to fall off from the cap frame 20 during opening for use, resulting in the multi-carrier cartridge remaining in an open state after use, posing a risk of contamination. On the other hand, a too large area ratio may indicate insufficient connection between the opening connection portion of the liquid carrier and the encapsulation portion 30, which can easily lead to the encapsulated multi-carrier cartridge being unable to rely on the first sealing type connection to reliably encapsulate liquid reagents, making the multi-carrier cartridges unsuitable for long-term storage. The multi-carrier cartridge provided in the present embodiment retains the advantage of easy opening and closing of the hard connection, while the encapsulation portion 30 is capable of being in non-mechanical sealing connection to the liquid carrier, combining the respective advantages of the two different connections. Due to the non-mechanical sealing connection 2001 between the opening connection portion of the liquid carrier and the encapsulation portion 30 by gluing or thermal encapsulation, i.e. non-mechanical sealing connection, wherein the method can also be welding or electrofusion ect., the non-mechanical sealing connection enables the liquid to be reliably encapsulated and can be suitable for long-term storage without leakage or seepage. During use, a mechanical external force is applied to the cap frame 20, causing the cap frame 20 and the encapsulation portion 30 to detach from the cartridge body 10 together. This destroys the non-mechanical sealing connection between the liquid carrier and the encapsulation portion 30, as well as the first mechanical connection 1001 and the second mechanical connection 1002. After use, the cap frame 20 and the encapsulation portion 30 can be fastened onto the cartridge body 10 again to form the first mechanical connection 1001 and the second mechanical connection 1002. Although the non-mechanical sealing of the liquid carrier is broken, that is, the non-mechanical sealing connection 2001 is broken, the second mechanical connection 1002 in interference fit can still play a mechanical sealing role, and the multi-carrier cartridge that is reclosed can still achieve the goal of carrier being closed. This greatly reduces the risk of contamination. It is also possible to ensure the effect of waste multi-carrier cartridges in preventing contamination through subsequent plastic sealing and other treatments.

The present embodiment divides the cap body of the multi-carrier cartridge into two parts, the cap frame 20 and the encapsulation portion 30, by separating the design thinking. During use, the cap frame 20 and the encapsulation portion 30 are detached from the cartridge body 10 together, and the sealing cap can be mechanically connected to the cartridge body 10 by the annular structure after use, realizing reclosing of the cartridge body 10, without damaging the encapsulation portion 30, which can facilitate unobstructed extraction and minimize the risk of contamination.

In the present embodiment, the same first material (polypropylene material) is used for the cap frame 20 and the cartridge body 10, resulting in strong sealing reliability between the cap frame 20 and the cartridge body 10 during use. A second material, different from the first material, is used for the encapsulation portion, and the second material is specifically aluminum foil. The sealing of the encapsulation portion 30 is gluing or thermal encapsulation, further ensuring the reliability of non-mechanical sealing connection.

### Embodiment 2

A sealing cap, as shown in FIGS. 4-6, comprises a cap frame 20 and an encapsulation portion 30, wherein the cap frame 20 is provided on one side with a number of annular structures mechanically connectable to an opening connection portion of a carrier, and on the other side with an encapsulation portion 30; the encapsulation portion 30 is made of a flexible material, and the encapsulation portion 30 is able to form non-mechanical sealing connection to an opening connection portion which passes through the annular structures, so that the carrier is in a sealing state at this connection type.

The annular structure is divided into a through type annular structure that passes through the cap frame 20 and a non-through type annular structure that forms a groove in the cap frame 20.

Eight annular structures are arranged at intervals along the length direction of the cap frame 20, the annular structures at the ends are non-through type annular structures and the annular structures in the middle are through type annular structures; the annular structures of the non-through type annular structures are provided with fastening structures fastened to the opening connection portion of a carrier, the non-through type annular structures are able to be fastened to a corresponding opening connection portion through the fastening structure to form the first mechanical connection 1001, and the annular structures of the through type annular structures are able to be in interference fit to corresponding opening connection portions of the carriers to form the second mechanical connections 1002. The cap frame 20 is provided with a number of opens that can reduce the stiffness of the cap frame 20, and the opens are located between two adjacent annular structures corresponding to the through type annular structures.

### Embodiment 3

A one-step encapsulation method is used to prepare the multi-carrier cartridge in Embodiment 1, comprising the following steps:

loading step: placing various objects to a number of carriers;
assembly step: assembling the cap frame 20 to the top of the cartridge body 10 so that the opening connection portion of the carrier can be inserted into the corresponding annular structure;
encapsulation step: placing the divided encapsulation portion 30 on top of the cap frame, connecting the encapsulation portion 30 to the cap frame 20 by means of gluing or thermal encapsulation, meanwhile, forming non-mechanical sealing connection between the opening connection portion of the encapsulation portion 30 and the encapsulation portion 30 by means of gluing or thermal encapsulation.

In the present embodiment, the non-mechanical sealing connection between at least part of the top of the cap frame 20 and the encapsulation portion 30 can be gluing or thermal encapsulation, and the non-mechanical sealing connection between the opening connection portion and the encapsulation portion 30 can also be gluing or thermal encapsulation. For example, a sealed multi-carrier cartridge can be obtained by using a gluing machine to apply adhesive to at least part of the top of the cap frame 20 and/or the position of the encapsulation portion 30 corresponding thereto, and to apply adhesive to the opening connection portion and/or the position of the encapsulation portion 30 corresponding thereto, and finally pressing and air drying. The thermal encapsulation is relatively simpler, only the multi-carrier cartridges in the complete assembly step are placed into the thermal encapsulation machine, and at least part of the top of the cap frame 20 is thermally encapsulated with the encapsulation portion 30 under the action of heat, and the opening connection portion of the liquid carrier which passes through the annular structure is also thermally encapsulated with the encapsulation portion 30. In some cases, the encapsulation portion 30 does not have to be cut in advance, and the encapsulation portion 30 can be cut on-site using production equipment to adapt it to the cap frame 20 after the cap frame has been laid down, and the present invention is not unqualified in this regard.

In the above thermal encapsulation, i.e., the parameters for forming non-mechanical sealing connection between the cap frame 20 and the encapsulation portion 30 include: a temperature of 170° C., a time of 5 S, and a pressure of 0.5 MPa; and the parameters for forming non-mechanical sealing connection between the encapsulation portion 30 and the opening connection portion of the liquid carrier which passes through the annular structure include: a temperature of 165° C., a time of 3.7 S, and a pressure of 0.5 MPa.

A coated appearance test after completing the thermal encapsulation of the multi-carrier cartridge comprises: after the cap frame 20 is coated, there is no obvious overflow of adhesive around the cap frame 20, and the cap frame 20 and the encapsulation portion 30 are well adhered to each other, without gaps and wrinkles. The visual inspection of the multi-carrier cartridge after coating and cooling comprises the following visual inspection criteria: the multi-carrier cartridge should be even in width at all edges and have a clear embossed pattern. Sealing test can be executed by randomly selecting 50 pieces per batch, adding 800 ul of sample preservation solution to the liquid carrier of the multi-carrier cartridge, completing the coating and cooling completely, placing it upside down in a shaker at 37° C./200 rmp for a 24-hour shock test, and checking for leakage after 24 hours, and no leakage is considered as a pass. Biological experimental test can be executed by randomly selecting the coated multi-carrier cartridges, adding the nucleic acid extraction reagent, and standing at 45° C. for 3 days, and testing with nucleic acid extraction reagent quality control reference products. The experimental data should meet the functional assessment and accelerated stability requirements outlined in the relevant standards. After accelerated experiments and destructive experiments and other verifications, the multi-carrier cartridge of the present invention can be adapted to the needs of long-term storage, and can adapt to the long-term bumpy type long-distance transport, and even long-term sea transport can still provide reliable sealing. After that, the results of the biological experiments have good reproducibility, and the results are more reliable.

### Embodiment 4

Embodiment 4 replaces the preparation method in Embodiment 3, and is an alternative for Embodiment 3; to further illustrate, the same components are not repeated herein, and a two-step encapsulation method is used to prepare the multi-carrier cartridge in Embodiment 1, specifically comprising the following steps:

loading step: placing various objects to a number of carriers;
encapsulation step: connecting the cap frame 20 and the encapsulation portion 30 by means of gluing or thermal encapsulation to form an integrated sealing cap, and subsequently, fastening the integrated sealing cap to the cartridge body 10, so that the opening connection portion of the carrier extends into the corresponding annular structure, and forming non-mechanical sealing connection between the encapsulation portion 30 and the opening connection portion which passes through the annular structure by means of gluing or thermal encapsulation again, with the sealing encapsulation completed.

### Embodiment 5

A method of using a multi-carrier cartridge is applied to a multi-carrier cartridge, wherein the multi-carrier cartridge comprises a cartridge body 10 and a sealing cap, and the cartridge body 10 and the sealing cap are detachably connected; the cartridge body 10 is provided with a number of carriers having opening connection portions; the sealing cap comprises a cap frame 20 and an encapsulation portion 30, wherein the cap frame 20 is provided on one side with a number of annular structures capable of being fastened to an opening connection portion of a carrier, and on the other side with an encapsulation portion 30; the encapsulation portion 30 is made of a flexible material, and the encapsulation portion 30 is able to form non-mechanical sealing connection to an opening connection portion which passes through the annular structures, so that the carrier is in a sealing state at this connection type; the annular structure is divided into a through type annular structure that passes through the cap frame 20 and a non-through type annular structure that forms a groove in the cap frame 20; the carrier comprises a liquid carrier for storing liquid, and a non-liquid carrier; the liquid carrier corresponds to the through type annular structure, and the non-liquid carrier corresponds to the non-through type annular structure; a first fastening structure is located on the side wall of the opening connection portion corresponding to the non-liquid carrier, and a second fastening structure is located on the side wall of the annular structure; the first fastening structure can cooperate with the second fastening structure to form a first mechanical connection 1001 that can be opened and closed, and the opening connection portion of the liquid carrier can be inserted into the corresponding annular structure and form a second mechanical connection 1002 through interference fit; the method of using the multi-carrier cartridge comprises the following stages:

Encapsulated stage: adding sample-associated reagents to the liquid carrier of the multi-carrier cartridge, placing the magnetic rod cover and/or pipette tip in the non-liquid carrier, assembling the cap frame 20 to the cartridge body 10, so that the annular structure is mechanically connected to the opening connection portion of the corresponding carrier, the non-liquid carrier is closed, and the encapsulation portion 30 is connected to the cap frame 20, meanwhile, the encapsulation portion 30 and the liquid carrier form non-mechanical sealing;
operated stage: applying an external force to the sealing cap, causing the cap frame 20 and encapsulation portion 30 to detach from the cartridge body 10 together, with the cartridge body 10 being in the uncapped state, and transferring the sample liquid or magnetic object to the liquid carrier for extraction and purification by using the pipette tip and/or the magnetic rod cover;
closed stage: after completing the reaction, fastening the cartridge body 10 and the sealing cap again, making the carrier and the sealing cap mechanically connected, so that the cartridge body 10 is in a capped state to avoid causing contamination.

In this text, specific embodiments are taken to describe the principles and implementations of the present invention, and the description of the above-mentioned embodiments is only intended to throw light upon the methods and core concepts of the present invention. It should be pointed out that for those of ordinary skill in the art, without breaking away from the principles of the present invention, certain improvements and modifications may be made to the present invention, which also fall within the scope of protection of the claims of the present invention.

For description of the present invention, it should be noted that orientation or position relations indicated by the terms “center”. “above”, “under”, “left”, “right”, “vertical”, “horizontal”, “inside”, “outside” etc. are based on the orientation or position relations shown in the figures or the commonly arranged orientation or position relations as used in the invention, and they are used to describe the invention and simplify description herein instead of indicating or implying that the device or component indicated must have specific orientation and be constructed and operated in specific orientation. Therefore, the embodiments described herein shall not be construed as limitation hereto.

In the description of the present invention, it should be also noted that, unless otherwise specified and defined explicitly, the terms “arrangement”, “assembly”, “linking” and “connection” shall be comprehend in a broad sense, for example, it can be fixed connection, and can also be removable connection, or integral connection; can be mechanical connection, and can also be electrical connection; can be direct linking, and can be indirect linking through an intermediary, or connection in two pieces. Those of ordinary skill in the art can understand the specific meanings of these terms in the present invention according to actual conditions.

1. A scaling cap, comprising a cap frame and an encapsulation portion, wherein the cap frame is provided with a number of annular structures on one side and the encapsulation portion on the other side; and the annular structure can be mechanically connected to an opening connection portion of a carrier, wherein the encapsulation portion is made of a flexible material, which is able to form a non-mechanical sealing connection to an opening connection portion passing through an annular structure, and enable the carrier in a sealing state.

2. The sealing cap according to claim 1, wherein a number of annular structures comprise a through type annular structure that passes through the cap frame and a non-through type annular structure that forms a groove in the cap frame.

3. The sealing cap according to claim 2, wherein a plurality of annular structures are arranged at intervals along the length direction of the cap frame; and the annular structure near the cap frame end is a non-through type annular structure, and the annular structure in central section is a through type annular structure; wherein a non-through type annular structure is provided with a fastening structure that can be fastened to an opening connection portion of a carrier, which forms a first mechanical connection; wherein a through type annular structure can keep interference fit with an opening connection portion of a carrier, which forms a second mechanical connection.

4. The sealing cap according to claim 3, wherein the cap frame is designed with a number of opens that reducing the stiffness of the cap frame, and an open is located between two adjacent annular structures corresponding to two through type annular structures.

5. The sealing cap according to claim 1, wherein the encapsulation portion is in form of a film, and the thickness of which ranges from 0.01 to 0.2 mm.

6. A multi-carrier cartridge, comprising a cartridge body and a sealing cap, wherein the cartridge body and the sealing cap can be detachably connected; and the cartridge body comprising a number of carriers, which are provided with opening connection portions; and the sealing cap comprising a cap frame and an encapsulation portion, wherein the cap frame is provided with a number of annular structures on one side and an encapsulation portion on the other side; and an opening connection portion of a carrier can be mechanically connected to an annular structure; an opening connection portion of a carrier can form a non-mechanical sealing connection to the encapsulation portion passing through an annular structure, enabling the carrier in a sealing state.

7. The multi-carrier cartridge according to claim 6, wherein a number of annular structures comprise a through type annular structure that passes through the cap frame and a non-through type annular structure; wherein a number of carriers comprise a liquid carrier and a non-liquid carrier; and
a liquid carrier which storing liquid corresponds to a through type annular structure, wherein a non-liquid carrier corresponds to a non-through type annular structure.

8. The multi-carrier cartridge according to claim 7, wherein the cartridge body comprises a flange, and a plurality of carriers pass through the horizontal plane of the flange, by which they are connected to each other.

9. The multi-carrier cartridge according to claim 8, wherein the distance of the liquid carrier protruding from the horizontal plane of the flange is greater than that of the non-liquid carrier.

10. The multi-carrier cartridge according to claim 7, wherein the first fastening structure is located on the side wall of the opening connection portion corresponding to the non-liquid carrier, and the second fastening structure is located on the side wall of a non-through annular structure; and the first fastening structure can be fastened to the second fastening structure, which forms the first mechanical connection; and the opening connection portion corresponding to the liquid carrier comprises an open side wall and a sealing side wall connected thereto, and the sealing side wall is located below the open side wall; and the outer wall diameter of the sealing side wall is greater than that of the open side wall, and the open side wall cooperates with the sealing forming a protruding-type structure; and the opening connection portion of the liquid carrier can be inserted into the corresponding annular structure, which forms the second mechanical connection by interference fit.

11. The multi-carrier cartridge according to claim 7, wherein a number of carriers are arranged at intervals along the length of the cartridge body, the carrier at one end is a non-liquid carrier and the carrier in the middle is a liquid carrier.

12. The multi-carrier cartridge according to claim 11, wherein a non-liquid carrier comprises a number of consumable receiving sub-wells, and the consumable receiving sub-wells corresponding to the same non-liquid carrier are adjacent to each other, which share the same opening connection portion.

13. A method for producing a multi-carrier cartridge of claim 6, wherein the multi-carrier cartridge comprises a cartridge body and a sealing cap, wherein the cartridge body and the sealing cap can be detachably connected; and the cartridge body comprises a number of carriers, which are provided with opening connection portions; and the sealing cap comprises a cap frame and an encapsulation portion, wherein the cap frame is provided with a number of annular structures on one side and an encapsulation portion on the other side; wherein the encapsulation portion is in form of a film; wherein the method for producing the multi-carrier cartridge comprises the following steps:
loading step: placing various objects to a number of carriers;
assembling step: assembling the cap frame to the top of the cartridge body so that an opening connection portion of a carrier can be inserted into can be inserted into the corresponding annular structure;
connecting the encapsulation portion step: connecting the encapsulation portion to the cap frame by means of gluing or thermal encapsulation;
encapsulating step: gluing or thermal encapsulation the contacting area between the opening connection portion and the encapsulation portion, which forms non-mechanical sealing connection;
wherein connecting the encapsulation portion step is synchronized with encapsulating step forming a one-step encapsulation method, or which is performed prior to the assembly step forming a two-step encapsulation method.

14. The method for producing a multi-carrier cartridge according to claim 13, wherein a number of annular structures comprise a through type annular structure that passes through the cap frame and a non-through type annular structure that forms a groove in the cap frame; wherein a number of carriers comprises a liquid carrier and a non-liquid carrier; and a liquid carrier which storing liquid corresponds to a through type annular structure and a non-liquid carrier corresponds to a non-through type annular structure; wherein the first fastening structure is located on the side wall of the opening connection portion corresponding to the non-liquid carrier, and the second fastening structure is located on the side wall of a non-through type annular structure; wherein the first fastening structure can be fastened to the second fastening structure, which forms the first mechanical connection; and the opening connection portion of the liquid carrier can be inserted into the corresponding annular structure, which forms the second mechanical connection by interference fit; during the loading step, wherein a liquid carrier is loaded with liquid, and a non-liquid carrier is loaded with a non-liquid material; during the assembling step, wherein the opening connection portion corresponding to the non-liquid carrier is mechanically connected to the corresponding annular structure, which forms a first mechanical connection, wherein the opening connection portion of the liquid carrier achieves interference fit to the corresponding annular structure, which forms the second mechanical connection, and the opening connection portion of the liquid carrier passes through the corresponding annular structure; and during encapsulating step, the opening connection portion of the liquid carrier and the encapsulation portion forms a non-mechanical sealing connection.

15. A method of using a multi-carrier cartridge, wherein the multi-carrier cartridge comprises a cartridge body and a sealing cap, wherein the cartridge body and the sealing cap can be detachably connected; and the cartridge body comprises a number of carriers, which are provided with opening connection portions; and the sealing cap comprises a cap frame and an encapsulation portion; wherein the cap frame is provided with a number of annular structures on one side and the encapsulation portion on the other side; wherein the encapsulation portion is in form of a film; wherein an opening connection of a carrier can form a non-mechanical sealing connection to the encapsulation portion passing through an annular structure, enabling the carrier in a sealing state; wherein a number of annular structures comprise a through type annular structure that passes through the cap frame and a non-through type annular structure that forms a groove in the cap frame; wherein a number of carriers comprise a liquid carrier and a non-liquid carrier; and a liquid carrier which storing liquid corresponds to a through type annular structure and a non-liquid carrier corresponds to a non-through type annular structure; wherein the first fastening structure is located on the side wall of the opening connection portion corresponding to the non-liquid carrier, and the second fastening structure is located on the side wall of a non-through annular structure; wherein the first fastening structure can be fastened to the second fastening structure, which forms the first mechanical connection; and the opening connection portion of the liquid carrier can be inserted into the corresponding annular structure, which forms the second mechanical connection by interference fit; wherein the method of using the multi-carrier cartridge comprises the following stages:
encapsulated-state: adding sample-associated reagents to a liquid carrier of the multi-carrier cartridge, placing the magnetic rod cover and/or a pipette tip in a non-liquid carrier, assembling the cap frame to the cartridge body, so that the annular structure is mechanically connected to the opening connection portion of the corresponding carrier, and the non-liquid carrier is closed, wherein the encapsulation portion is connected to the cap frame, meanwhile, which forms non-mechanical sealing connection making the cartridge turning into an sealed-state cartridge;
operated stage: applying an external force to the sealing cap, causing the cap frame and encapsulation portion to detach from the cartridge body together, making the cartridge body in the uncapped state, and transferring the sample liquid or magnetic beads to a liquid carrier for extraction and purification by using the pipette tip and/or the magnetic rod cover;
closed stage: after completing the reaction, reclosing the cartridge body and the sealing cap again, making the carrier and the sealing cap mechanically connected, so that the cartridge body is in a capped state to avoid causing contamination.
